(19) United States
(12) Patent Application Publication
(10) Pub. No.: US 2006/0153995 A1
(43) Pub. Date: Jul. 13, 2006

(54) Method for fabricating a dielectric stack

(75) Inventors: Pravin K. Narwankar, Sunnyvale, CA (US); Shreyas S. Kher, Campbell, CA (US); Shankar Muthukrishnan, San Jose, CA (US); Rahul Sharangpani, Fremont, CA (US); Philip Kraus, San Jose, CA (US); Chris Olsen, Fremont, CA (US); Khaled Z. Ahmed, Anaheim, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/298,553

(22) Filed: Dec. 9, 2005

Related U.S. Application Data
(63) Continuation-in-part of application No. 11/167,070, filed on Jun. 24, 2005.
Application No. 11/167,070 is a continuation-in-part of application No. 10/851,514, filed on May 21, 2004.

(51) Int. Cl. H05H 1/24

(52) U.S. Cl. 427/569

(57) ABSTRACT

Methods for forming dielectric materials on a substrate in a single cluster tool are provided. In one embodiment, the method includes providing a cluster tool having a plurality of deposition chambers, depositing a metal-containing oxide layer on a substrate in a first chamber of the cluster tool, treating the metal-containing oxide layer with an insert plasma process in a second chamber of the cluster tool, annealing the metal-containing oxide layer in a third chamber of the cluster tool, and depositing a gate electrode layer on the annealed substrate in a fourth chamber of the cluster tool.

### CROSS-REFERENCE TO RELATED APPLICATIONS

This application is a continuation-in-part of U.S. patent application Ser. No. 11/167,070, entitled “Plasma Treatment of Hafnium-Containing Materials,” filed on Jun. 24, 2005, which is a continuation-in-part of U.S. patent application Ser. No. 10/851,514, entitled “Stabilization of High-K Dielectric Material,” filed on May 21, 2004. Each of the aforementioned related patent applications is herein incorporated by reference in its entirety.

### BACKGROUND OF THE INVENTION

1. Field of the Invention

Embodiments of the invention generally relate to methods for depositing materials on substrates in a cluster tool, and more specifically, to methods for depositing dielectric materials while forming a dielectric stack in an integrated cluster tool.

2. Description of the Related Art

Integrated circuits may include more than one million micro-electronic field effect transistors (e.g., complementary metal-oxide-semiconductor (CMOS) field effect transistors) that are formed on a substrate (e.g., semiconductor wafer) and cooperate to perform various functions within the circuit. A CMOS transistor comprises a gate structure disposed between source and drain regions that are formed in the substrate. The gate structure generally comprises a gate electrode and a gate dielectric. The gate electrode is disposed over the gate dielectric to control a flow of charge carriers in a channel region formed between the drain and source regions beneath the gate dielectric. To increase the speed of the transistor, the gate dielectric may be formed from a material having a dielectric constant greater than 4.0. Herein such dielectric materials are referred to as high-k materials.

Fabrication of gate structures of field effect transistors having the high-k gate dielectric comprises a series of processing steps (e.g., depositing multiple layers) which are performed using various substrate processing reactors. In a gate stack structure forming process, not only conformal films are required, but also the good qualities of the interfacial layers between each layer are essential.

In conventional CMOS fabrication schemes, the substrate is required to pass between tools having the various reactors coupled thereto. The process of passing the substrate between tools necessitates the removal of the substrate from the vacuum environment of one tool for transfer at ambient pressures to the vacuum environment of a second tool. In the ambient environment, the substrates are exposed to mechanical and chemical contaminants, such as particles, moisture, and the like, that may damage the gate structures being fabricated and possibly form an undesired interfacial layer, e.g., native oxide, between each layers while transferring. As gate structures become smaller and/or thinner to increase the device speed, the detrimental effect of forming interfacial layers or contamination becomes an increased concern. Additionally, the time spent on transferring the substrate between the cluster tools decreases productivity in manufacture of the field effect transistors.

Therefore, there is a need for process integration and an improved cluster tool for the manufacture of gate structures for field effect transistors.

### SUMMARY OF THE INVENTION

Methods for forming dielectric materials on a substrate in a single cluster tool are provided. In one embodiment, a method includes providing a cluster tool having a plurality of deposition chambers, depositing a metal-containing oxide layer on a substrate in a first chamber of the cluster tool, treating the metal-containing oxide layer with an insert plasma process in a second chamber of the cluster tool, annealing the metal-containing oxide layer in a third chamber of the cluster tool, and depositing a gate electrode layer on the annealed treated metal-containing oxide layer in a fourth chamber of the cluster tool.

In another embodiment, the method includes providing a cluster tool having a plurality of deposition chambers, precleaning a substrate in the cluster tool, depositing a metal-containing oxide layer on the substrate in a first chamber of the cluster tool, treating the metal-containing oxide layer with an insert plasma process in a second chamber of the cluster tool, annealing the metal-containing oxide layer in a third chamber of the cluster tool, and depositing a gate electrode layer on the annealed treated metal-containing oxide layer in a fourth chamber of the cluster tool.

In yet another embodiment, the method includes providing a cluster tool having a plurality of deposition chambers, precleaning a substrate in the cluster tool, depositing a metal-containing oxide layer on the substrate in the cluster tool, annealing the metal-containing oxide layer with a post deposition anneal process in the cluster tool, treating the metal-containing oxide layer with an insert plasma process in the cluster tool, annealing the treated metal-containing oxide layer in the cluster tool, and depositing a gate electrode layer on the annealed, treated metal-containing oxide layer in the cluster tool.

### BRIEF DESCRIPTION OF THE DRAWINGS

The teachings of the present invention can be readily understood by considering the following detailed description in conjunction with the accompanying drawings, in which:

FIG. 1 illustrates a schematic diagram of an exemplary integrated semiconductor substrate processing system (e.g., a cluster tool) of the kind used in one embodiment of the invention;

FIG. 2 illustrates a flow chart of an exemplary process for depositing dielectric layers on the substrate in the cluster tool in FIG. 1; and

FIG. 3A-E illustrates a substrate during various stages of the process sequence referred to in FIG. 2.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally provide methods and a system for preparing dielectric materials used in a variety of applications, such as a gate stack layers used in field effect transistors fabrication. In one embodiment, a dielectric material or a dielectric stack is deposited in an integrated cluster tool. In another embodiment, a dielectric material or a dielectric stack is prepared by depositing a dielectric layer containing a metal oxide, e.g., a high-k material, on the substrate by an ALD process, by exposing the substrate to an inert gas plasma process, subsequently exposing the substrate to a thermal annealing process and depositing a polysilicon gate layer and/or a metal gate layer in an integrated cluster tool without breaking vacuum (e.g., all processes are preformed in-situ the tool). Optionally, the substrate may be precleaned prior the first dielectric layer deposited thereon in-situ the same tool.

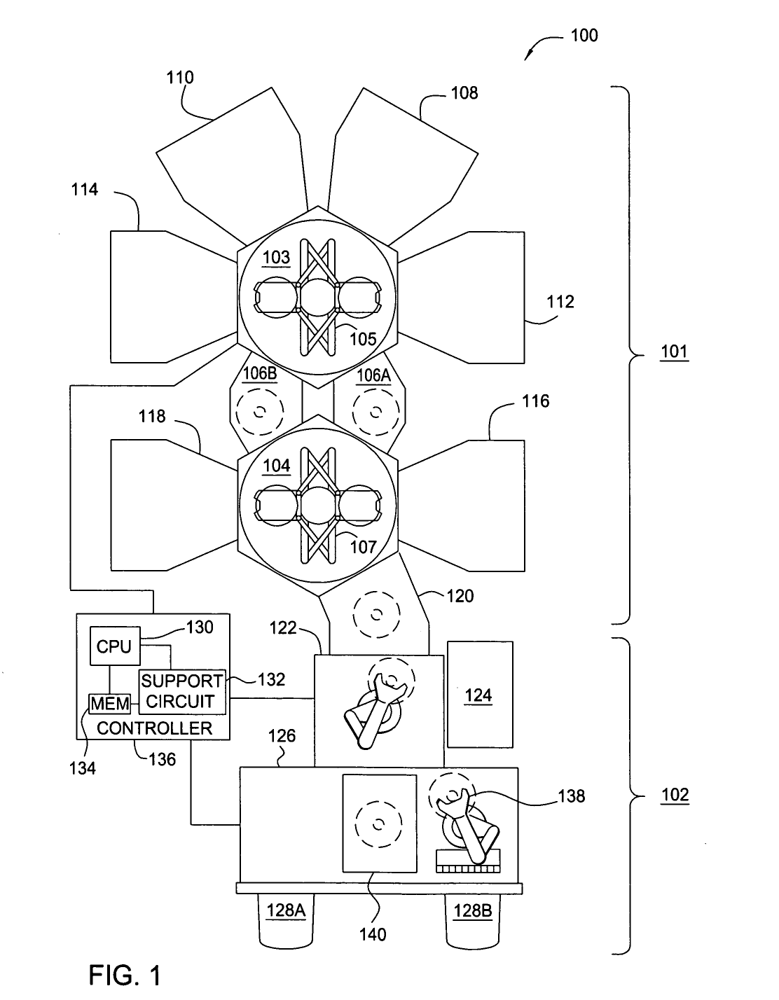

FIG. 1 depicts a schematic diagram of an exemplary integrated semiconductor substrate processing system (e.g., cluster tool 100) of the kind used in one embodiment of the invention. It is contemplated that the methods described herein may be practiced in other tools having the requisite process chambers coupled thereto.

The tool 100 includes a vacuum-tight processing platform 101, a factory interface 102, and a system controller 136. The platform 101 comprises a plurality of processing modules 110, 108, 114, 112, 118, 116, 124 and at least one load-lock chamber (a load-lock chamber 120 is shown), which are coupled to vacuum substrate transfer chambers 103, 104. The factory interface 102 is coupled to the transfer chamber 104 by the load lock chamber 120.

In one embodiment, the factory interface 102 comprises at least one docking station, at least one substrate transfer robot 138, at least one substrate transfer platform 140, at least one preclean chamber 124, and a precleaning robot 122 The docking station is configured to accept one or more front opening unified pod (FOUP). Two FOUPs 128A, 128B are shown in the embodiment of FIG. 1. The substrate transfer robot 138 is configured to transfer the substrate from the factory interface 102 to the precleaning chamber 124 wherein a precleaning process may be performed. The precleaning robot 122 is configured to transfer the substrate from the precleaning chamber 124 to the loadlock chamber 120. Alternatively, the substrate may be transferred from the factory interface 102 directly to the loadlock chamber 120, by-passing the precleaning chamber 124.

The loadlock chamber 120 has a first port coupled to the factory interface 102 and a second port coupled to a first transfer chamber 104. The loadlock chamber 120 is coupled to a pressure control system (not shown) which pumps down and vents the chamber 120 as needed to facilitate passing the substrate between the vacuum environment of the transfer chamber 104 and the substantially ambient (e.g., atmospheric) environment of the factory interface 102.

The first transfer chamber 104 and the second transfer chamber 103 respectively have a first robot 107 and a second robot 105 disposed therein. Two substrate transfer platforms 106A, 106B are disposed in the transfer chamber 104 to facilitate transfer of the substrate between robots 105, 107. The platforms 106A, 106B can either be open to the transfer chambers 103, 104 or be selectively isolated (i.e., sealed) from the transfer chambers 103, 104 to allow different operational pressures to be maintained in each of the transfer chambers 103, 104.

The robot 107 disposed in the first transfer chamber 104 is capable of transferring substrates between the loadlock chamber 120, the processing chambers 116, 118 and the substrate transfer platforms 106A, 106B. The robot 105 disposed in the second transfer chamber 103 is capable of transferring substrates between the substrate transfer platforms 106A, 106B and the processing chambers 112, 114, 110, 108.

In one embodiment, the processing chambers coupled to the first transfer chamber 104 may be a metalorganic chemical vapor deposition (MOCVD) chamber 118 and a Decoupled Plasma Nitridation (DPN) chamber 116. The processing chambers coupled to the second transfer chamber 103 may be a Rapid Thermal Process (RTP) chamber 114, a chemical vapor deposition (CVD) chamber 110, a first atomic layer deposition (ALD) chamber 108, and a second atomic layer deposition (ALD) chamber 112. Suitable ALD, CVD, PVD, DPN, RTP, and MOCVD processing chambers are available from Applied Materials, Inc., located in Santa Clara, Calif.

The system controller 136 is coupled to the integrated processing tool 100. The system controller 136 controls the operation of the tool 100 using a direct control of the process chambers of the tool 100 or alternatively, by controlling the computers (or controllers) associated with the process chambers and tool 100. In operation, the system controller 140 enables data collection and feedback from the respective chambers and system to optimize performance of the system 100.

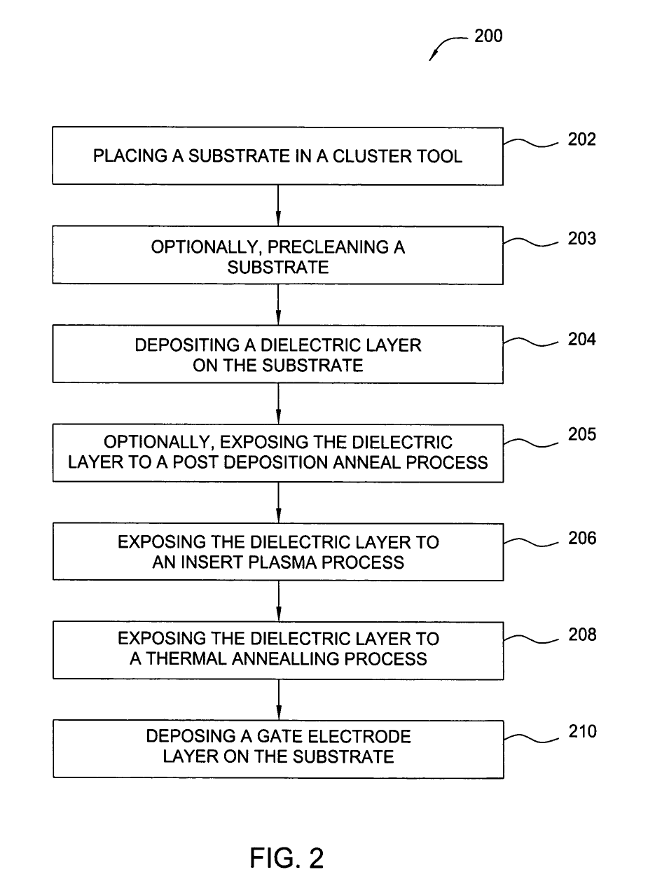

The system controller 136 generally comprises a central processing unit (CPU) 130, a memory 134, and support circuit 132. The CPU 130 may be one of any form of a general purpose computer processor that can be used in an industrial setting. The support circuits 132 are conventionally coupled to the CPU 130 and may comprise cache, clock circuits, input/output subsystems, power supplies, and the like. The software routines, such as a dielectric deposition process 200 described below with reference to FIG. 2, when executed by the CPU 130, transform the CPU into a specific purpose computer (controller) 136. The software routines may also be stored and/or executed by a second controller (not shown) that is located remotely from the tool 100.

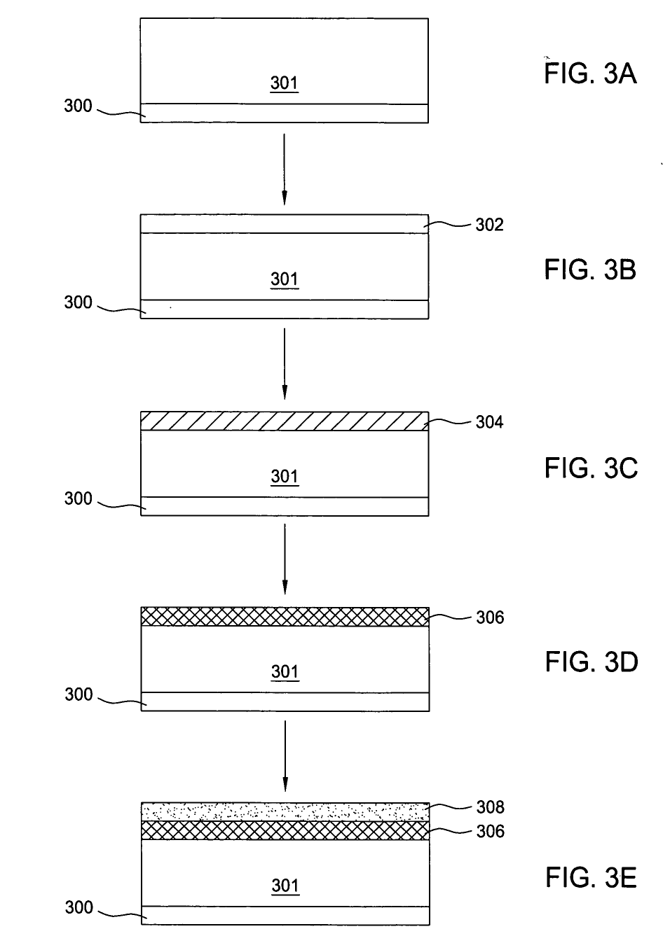

FIG. 2 illustrates a flow chart of one embodiment of a process 200 for deposition dielectric layers on the substrate in an integrated cluster tool, such as the tool 100 described above. FIGS. 3A-3E are schematic, cross-sectional views corresponding to different stages of the process 200.

The method 200 begins at step 202 with positioning a substrate 300 in the tool 100. The substrate 300, as shown in FIG. 3A, refers to any substrate or material surface upon which film processing is performed. For example, the substrate 300 may be a material such as crystalline silicon (e.g., Si<100> or Si<111>), silicon oxide, strained silicon, silicon germanium, doped or undoped polysilicon, doped or undoped silicon wafers and patterned or non-patterned wafers silicon on insulator (SOI), carbon doped silicon oxides, silicon nitride, doped silicon, germanium, gallium arsenide, glass, sapphire. The substrate 300 may include a layer 301 disposed thereon. In embodiments wherein the layer 301 is not present, processes described as performed on the layer 301 may alternatively be on the substrate 300.

The layer 301 may be any material, such as metals, metal nitrides, metal alloys, and other conductive materials, barrier layers, titanium, titanium nitride, tungsten nitride, tantalum and tantalum nitride, a dielectric material, or silicon. The substrate 300 may have various dimensions, such as 200 mm or 300 mm diameter wafers, as well as, rectangular or square panes. Unless otherwise noted, embodiments and examples described herein are conducted on substrates with a 200 mm diameter or a 300 mm diameter. The substrate 300, with or without the layer 301, may be exposed to a pretreatment process to polish, etch, reduce, oxidize, hydroxylate, anneal and/or bake the upper surface.

At an optional step 203, precleaning of the layer 301 disposed on the substrate 300 is performed. The precleaning step 203 is configured to cause compounds exposed on the surface of the layer 301 to terminate in a functional group. Functional groups attached and/or formed on the surface of the layer 301 include hydroxyls (OH), alkoxy (OR, where R=Me, Et, Pr or Bu), haloxyls (OX, where X=F, Cl, Br or I), halides (F, Cl, Br or I), oxygen radicals and aminos (NR or NR₂, where R=H, Me, Et, Pr or Bu). The precleaning process may expose the layer 301 to a reagent, such as NH₃, B₂H₆, SiH₄, SiH₆, H₂O, HF, HCl, O₂, O₃, H₂O, H₂O₂, H₂, atomic-H, atomic-N, atomic-O, alcohols, amines, plasmas thereof, derivatives thereof or combination thereof. The functional groups may provide a base for an incoming chemical precursor to attach on the surface of the layer 301. In one embodiment, the precleaning process may expose the surface of the layer 301 to a reagent for a period from about 1 second to about 2 minutes. In another embodiment, the exposure period may be from about 5 seconds to about 60 seconds. Precleaning processes may also include exposing the surface of the layer 301 to an RCA solution (SC1/SC2), an HF-last solution, water vapor from WVG or ISSG systems, peroxide solutions, acidic solutions, basic solutions, plasmas thereof, derivatives thereof or combinations thereof. Useful precleaning processes are described in commonly assigned U.S. Pat. No. 6,858,547 and co-pending U.S. patent application Ser. No. 10/302,752, filed Nov. 21, 2002, entitled, “Surface Pre-Treatment for Enhancement of Nucleation of High Dielectric Constant Materials,” and published as US 20030232501, which are both incorporated herein by reference in their entirety.

In one example of a precleaning process, a native oxide layer is removed prior to exposing substrate 300 to a wet-clean process to form a chemical oxide layer having a thickness of about 10 Å or less, such as from about 5 Å to about 7 Å. Native oxides may be removed by a HF-last solution. The wet-clean process may be performed in a TEMPEST™ wet-clean system, available from Applied Materials, Inc. In another example, substrate 300 is exposed to water vapor derived from a WVG system for about 15 seconds.

At step 204, the dielectric layer 302 is deposited on the layer 301 in a process chamber, as shown in FIG. 3B. The dielectric layer 302 may be a metal oxide, and may be deposited by an ALD process, a MOCVD process, a conventional CVD process or a PVD process. These processes may be preformed in one of the chambers described above.

In one embodiment, the dielectric layer 302 may be deposited in an deposition process chamber containing an oxidizing gas and at least one precursor, such as a hafnium precursor, a zirconium precursor, a silicon precursor, an aluminum precursor, a tantalum precursor, a titanium precursor, a lanthanum precursor or combinations thereof, supplied thereto. Examples of dielectric materials that may be formed during the deposition process include hafnium oxide, zirconium oxide, lanthanum oxide, tantalum oxide, titanium oxide, aluminum oxide, derivatives thereof or combinations thereof.

In one embodiment, an ALD process may deposit metal oxide materials to form the layer 302. In one embodiment, the ALD process is performed at a chamber pressure from about 1 Torr to about 100 Torr, or from about 1 Torr to about 20 Torr, or from about 1 Torr to about 10 Torr. The temperature of the substrate 300 may be maintained from about 70 degrees Celsius to about 1,000 degrees Celsius, or from about 100 degrees Celsius to about 650 degrees Celsius, or from about 250 degrees Celsius to about 500 degrees Celsius. A further disclosure of an ALD deposition process is described in commonly assigned U.S. patent application Ser. No. 11/127,767, filed May 12, 2005, entitled, “Apparatuses and Methods for Atomic Layer Deposition of Hafnium-containing High-K Materials,” which is incorporated herein by reference in its entirety.

In one example of an ALD process suitable for depositing the layer 302, a hafnium precursor is introduced into the process chamber at a rate from about 5 sccm to about 200 sccm. The hafnium precursor may be introduced with a carrier gas, such as nitrogen, with a total flow rate from about 50 sccm to about 1,000 sccm. The hafnium precursor may be pulsed into the process chamber at a rate from about 0.1 pulses per second to about 10 pulses per second, depending on the particular process conditions, hafnium precursor or desired composition of the deposited hafnium oxide material. In one embodiment, the hafnium precursor is pulsed into the process chamber at a rate from about 1 pulses per second to about 5 pulses per second, for example, about 3 pulses per second. In another embodiment, the hafnium precursor is pulsed into the process chamber at a rate from about 0.1 pulses per second to about 1 pulses per second, for example, about 0.5 pulses per second. In one example, the hafnium precursor may be hafnium tetrachloride (HfCl₄). In another example, the hafnium precursor may be a tetrakis(dialkylamino)hafnium compound, such as tetrakis(diethylamino)hafnium ((Et₂N)₄Hf or TDEAH).

The hafnium precursor is generally dispensed into a process chamber by introducing a carrier gas through an ampoule containing the hafnium precursor. An ampoule may include an ampoule, a bubble, a cartridge or other container used for containing or dispersing chemical precursors. A suitable ampoule, such as the PROE-VAP™, is available from Advanced Technology Materials, Inc., located in Danbury, Conn. In one example, the ampoule contains HfCl₄ at a temperature from about 150 degrees Celsius to about 200 degrees Celsius. In another example, the ampoule may contain a liquid precursor (e.g., TDEAH, TDMAH, TDMAS or Tris-DMAS) and be part of a liquid delivery system containing injector valve system used to vaporize the liquid precursor with a heated carrier gas. Generally, the ampoule may be pressurized from about 138 kPa (about 20 psi) to about 414 kPa (about 60 psi) and may be heated to a temperature of about 100 degrees Celsius or less, for example, from about 20 degrees Celsius to about 60 degrees Celsius.

The oxidizing gas may be introduced to the process chamber with a flow rate from about 0.05 sccm to about 1,000 sccm, for example, from about 0.5 sccm to about 100 sccm. The oxidizing gas is pulsed into the process chamber from about 0.05 pulses per second to about 10 pulses per second, for example, from about 0.08 pulses per second to about 3 pulses per second, and in another embodiment, from about 0.1 to about 2 pulses per second. In one embodiment, the oxidizing gas is pulsed at a rate from about 1 pulse per second to about 5 pulses per second, for example, about 1.7 pulses per second. In another embodiment, the oxidizing gas is pulsed at a rate from about 0.1 pulse per second to about 3 pulses per second, for example, about 0.5 pulses per second.

Many precursors are within the scope of embodiments of the invention for depositing materials for the dielectric layer 302. An important precursor characteristic is a favorable vapor pressure. Precursors at ambient temperature and pressure may be gas, liquid or solid. However, volatilized precursors are used within the ALD chamber. Organometallic compounds contain at least one metal atom and at least one organic-containing functional group, such as amides, alkyls, alkoxyls, alkylaminos or anilides. Precursors may include organometallic, inorganic or halide compounds.

Exemplary hafnium precursors include hafnium compounds containing ligands such as halides, alkylaminos, cyclopentadienyls, alkyls, alkoxides, derivatives thereof or combinations thereof. Hafnium halide compounds useful as hafnium precursors may include HfCl₄, HfI₄, and HfBr₄. Hafnium alkylamino compounds useful as hafnium precursors include (RR′N)₄Hf, where R or R′ are independently hydrogen, methyl, ethyl, propyl or butyl. Hafnium precursors useful for depositing hafnium-containing materials include (Et₂N)₄Hf, (Me₂N)₄Hf, (MeEtN)₄Hf, (^{t}BuC₅H₄)₂HfCl₂, (C₅H₅)₂HfCl₂, (EtC₅H₄)₂HfCl₂, (Me₅C₅)₂HfCl₂, (Me₅C₅)HfCl₃, (ⁱPrC₅H₄)₂HfCl₂, (ⁱPrC₅H₄)HfCl₃, (^{t}BuC₅H₄)₂HfMe₂, (acac)₄Hf, (hfac)₄Hf, (tfac)₄Hf, (thd)₄Hf, (NO₃)₄Hf, (^{t}BuO)₄Hf, (ⁱPrO)₄Hf, (EtO)₄Hf, (MeO)₄Hf or derivatives thereof. Moreover, hafnium precursors used during the deposition process herein include HfCl₄, (Et₂N)₄Hf or (Me₂N)₄Hf.

Subsequent the deposition process, substrate 300 may optionally be exposed to a post deposition anneal (PDA) process at step 205. Substrate 300 having the dielectric layer 302 disposed thereon is transferred to an annealing chamber 114, such as the RADIANCE™ RTP chamber. As the annealing chamber 114 is on the same cluster tool as the deposition chamber, the substrate 300 is annealed without being exposed to an ambient environment. Substrate 300 may be heated to a temperature from about 600 degrees Celsius to about 1,200 degrees Celsius, or from about 600 degrees Celsius to about 1,150 degrees Celsius, or from about 600 degrees Celsius to about 1,000 degrees Celsius. The PDA process may last for a time period from about 1 second to about 5 minutes, for example, from about 1 minute to about 4 minutes, and in another embodiment, from about 2 minutes to about 4 minutes. Generally, the chamber atmosphere contains at least one annealing gas, such as oxygen (O₂), ozone (O₃), atomic oxygen (O), water (H₂O), nitric oxide (NO), nitrous oxide (N₂O), nitrogen dioxide (NO₂), dinitrogen pentoxide (N₂O₅), nitrogen (N₂), ammonia (NH₃), hydrazine (N₂H₄), derivatives thereof or combinations thereof. Often the annealing gas contains nitrogen and at least one oxygen-containing gas, such as oxygen. The chamber may have a pressure from about 5 Torr to about 100 Torr, for example, about 10 Torr. In one example of a PDA process, substrate 200 containing oxide layer 202 is heated to a temperature of about 600° C. for about 4 minutes within an oxygen atmosphere.

In step 206, dielectric layer 302 is exposed to an inert plasma process to densify the dielectric material while forming plasma-treated layer 304, as depicted in FIG. 3C. The inert plasma process may include a decoupled inert gas plasma process performed by flowing an inert gas into a decoupled plasma nitridation (DPN) chamber (i.e., a DPN chamber 116) or a remote inert gas plasma process by flowing an inert gas into a process chamber equipped by a remote plasma system.

In one embodiment of an inert plasma process, substrate 300 is transferred into the DPN chamber 114. As the DPN chamber is on the same cluster tool as the ALD chamber used to deposit the dielectric layer 302 and the chamber optionally used for post deposition annealing, the substrate 300 is not exposed to an ambient environment associated with the transferring between cluster tools. During the transfer of the substrate, nitrogen gas may be purged in the transfer chambers 104, 103 to avoid the growth of an interfacial layer therebetween. In the inert plasma process, the dielectric layer 302 is bombarded with ionic argon formed by flowing argon into the DPN chamber. Gases that may be used in an inert plasma process include nitrogen containing gas, argon, helium, neon, xenon or combinations thereof.

If any nitrogen is flowed or co-flowed with the inert gas, the nitrogen will nitridize the dielectric material, such as converting metal oxides into metal oxynitrides. Trace amounts of nitrogen that likely exist in a DPN chamber used for nitridation process may inadvertently combine with the inert gas while performing a plasma process. The inert plasma process uses a gas that contains at least one inert gas or only a trace amount of nitrogen. In one embodiment, the nitrogen concentration due to residual nitrogen within the inert gas is about 1 percent by volume or less, for example, about 0.1 percent by volume or less, and in one embodiment, about 100 ppm or less, such as about 50 ppm. In one example, the inert plasma process comprises argon and is free of nitrogen or substantially free of nitrogen. Therefore, the inert plasma process increases the stability and density of the dielectric material, while decreasing the equivalent oxide thickness (EOT) unit.

The inert plasma process proceeds for a time period from about 10 seconds to about 5 minutes, for example, from about 30 seconds to about 4 minutes, and in one embodiment, from about 1 minute to about 3 minutes. Also, the inert plasma process is conducted at a plasma power setting from about 500 watts to about 3,000 watts, for example, from about 700 watts to about 2,500 watts, for example, from about 900 watts to about 1,800 watts. Generally, the plasma process is conducted with a duty cycle of about 50 percent to about 100 percent, and at a pulse frequency at about 10 kHz. The DPN chamber may have a pressure from about 10 mTorr to about 80 mTorr. The inert gas may have a flow rate from about 10 standard cubic centimeters per minute (sccm) to about 5 standard liters per minute (slm), or from about 50 sccm to about 750 sccm, or from about 100 sccm to about 500 sccm. In one embodiment, the inert plasma process is a nitrogen free argon plasma produced in a DPN chamber.

In another embodiment, the process chamber used to deposit dielectric layer 302 is also used during the inert plasma process of step 206 to form plasma-treated layer 304 without transferring substrate 300 between process chambers. For example, a remote argon plasma is exposed to dielectric layer 302 to form plasma-treated layer 304 directly within a process chamber configured with a remote-plasma device, such as an ALD chamber or a CVD chamber, that was used to deposit the dielectric layer 302. Other inert processes may be utilized to form an equivalent layer to the plasma-treated layer 304, such as treating the layer 302 with a laser.

At step 208, the plasma-treated layer 304 disposed on the substrate 300 is exposed to a thermal annealing process. In one embodiment, substrate 300 is transferred to an annealing chamber, such as the RTP chamber 114. An example of a suitable RTP chamber is the CENTURA™ RADIANCE™ RTP chamber, available from Applied Materials, Inc., and exposed to the thermal annealing process. As the annealing chamber 114 is on the cluster tool 100 as the deposition chamber and the nitridation chamber, the plasma-treated layer 304 may be annealed without being exposed to the ambient environment associated with transferring the substrate between cluster tools.

In one embodiment of an annealing process, the plasma-treated layer 304 may be heated to a temperature from about 600 degrees Celsius to about 1,200 degrees Celsius. In another embodiment, the temperature may be from about 700 degrees Celsius to about 1,150 degrees Celsius. In yet another embodiment, the plasma-treated layer 304 may be heated to a temperature from about 800 degrees Celsius to about 1,000 degrees Celsius. The thermal annealing process may have different durations. In one embodiment, the duration of the thermal annealing process may be from about 1 second to about 120 seconds. In another embodiment, the duration of the thermal annealing process may be from about 2 seconds to about 60 seconds. In yet another embodiment, the thermal annealing process may have a duration of about 5 seconds to about 30 seconds. Generally, the chamber atmosphere contains at least one annealing gas, such as oxygen (O₂), ozone (O₃), atomic oxygen (O), water (H₂O), nitric oxide (NO), nitrous oxide (N₂O), nitrogen dioxide (NO₂), dinitrogen pentoxide (N₂O₅), nitrogen (N₂), ammonia (NH₃), hydrazine (N₂H₄), derivatives thereof or combinations thereof. The annealing gas may contain nitrogen and at least one oxygen-containing gas, such as oxygen. The chamber may have a pressure from about 5 Torr to about 100 Torr, for example, about 10 Torr. In one example of a thermal annealing process, substrate 200 is heated to a temperature of about 1,050 degrees Celsius for about 15 seconds within an oxygen atmosphere. In another example, substrate 300 is heated to a temperature of about 1,100 degrees Celsius for about 25 seconds within an atmosphere containing equivalent volumetric amounts of nitrogen and oxygen during the annealing process.

The thermal annealing process converts the plasma-treated layer 304 to a dielectric material or post anneal layer 306, as depicted in FIG. 3D. The thermal annealing process repairs any damage caused by plasma bombardment during step 206 and reduces the fixed charge of post anneal layer 306. The dielectric material remains amorphous and may have a nitrogen concentration with different ranges. In one embodiment, the nitrogen concentration is from about 5 atomic percent to about 25 atomic percent. In another embodiment, the nitrogen concentration is from about 10 atomic percent to about 20 atomic percent, for example, about 15 atomic percent. Post anneal layer 306 may have different film thicknesses. In one embodiment, the thickness may be from about 5 Å to about 300 Å. In another embodiment, the thickness may be from about 10 Å to about 200 Å. In yet another embodiment, the thickness may be from about 20 Å to about 100 Å. In another example, post anneal layer 306 has a thickness from about 10 Å to about 60 Å, such as from about 30 Å to about 40 Å.

In step 210, a gate electrode layer 308 is deposited over the annealed dielectric layer 306, as depicted in FIG. 3E. The gate electrode layer 308 may be formed from a material selected for a predetermined device requirement. Generally, the gate electrode layer 308 may be formed by using a CVD process, such as MOCVD, LPCVD, PECVD, Vapor Phase Epitaxy (VPE), ALD or PVD. In one embodiment, the gate electrode layer 308 may be a polycrystalline-Si, amorphous-Si or other suitable material deposited by using a LPCVD chamber (i.e., the deposition chamber 110). One suitable chamber is a POLYGen chamber, available from Applied Materials, Inc. In another embodiment, the gate electrode layer 308 may comprise a metal and/or a metal-containing compound deposited in an ALD or a PVD chamber. In one exemplary embodiment, the gate electrode layer 308 is formed of tantalum silicon nitride (TaN). In alternate embodiments, the gate electrode layer 308 may comprise metals such as titanium (Ti), tantalum (Ta), ruthenium (Ru), molybdenum (Mo) and the like, and/or metal-containing compounds, such as tantalum nitride (TaN), titanium nitride (TiN), tantalum silicon nitride (TaSiN), titanium silicon nitride (TiSiN), tantalum carbide (TaC), titanium aluminum nitride (TiAlN), ruthenium tantalum (RuTa), molybdenum nitride (MoN), tungsten nitride (WN) and the like. In yet another embodiment, the gate electrode layer 308 may comprise a metal and/or metal-containing compound caped with a polycrystalline-Si or amorphous-Si on the top thereover. In one example, the gate electrode layer may be a metal layer such as titanium (Ti), tantalum (Ta), ruthenium (Ru), molybdenum (Mo) and the like, subsequently caped by a polycrystalline-Si or amorphous-Si over the top. In another example, the gate layer may be a metal layer such as titanium (Ti), tantalum (Ta), ruthenium (Ru), molybdenum (Mo), and the like, and/or metal-containing compounds, such as tantalum nitride (TaN), titanium nitride (TiN), tantalum silicon nitride (TaSiN), titanium silicon nitride (TiSiN), tantalum carbide (TaC), titanium aluminum nitride (TiAlN), ruthenium tantalum (RuTa), molybdenum nitride (MoN), tungsten nitride (WN) and the like, subsequently caped by a polycrystalline-Si or amorphous-Si layer thereover. All these metals, metal containing gate layers, or silicon layers may be performed in an ALD, CVD, or PVD chamber, all available from Applied Materials, Inc. As the gate electrode layer 308 is deposited in the cluster tool 100 having the deposition chamber, the nitridation chamber, and the thermal annealing chamber coupled thereto, the substrate 300 is not exposed to an ambient environment associated with the transferring between cluster tools.

Thus, methods for preparing dielectric materials that may be used for gate fabrication for field effect transistors have been provided. The method allows for the preparation and deposition of a dielectric material or a dielectric stack in an integrated cluster tool, thereby eliminating exposure to contaminants resulting from tool to tool transfer associated with conventional fabrication techniques.

While the foregoing is directed to embodiments of the invention, other and further embodiments of the invention may be devised without departing from the basic scope thereof, and the scope thereof is determined by the claims that follow.

What is claimed is:

1. A method for forming dielectric materials on a substrate in a single cluster tool, comprising:
providing a cluster tool having a plurality of deposition chambers;
depositing a metal-containing oxide layer on a substrate positioned in a first chamber of the cluster tool;
treating the metal-containing oxide layer with an insert plasma process in a second chamber of the cluster tool;
annealing the treated metal-containing oxide layer in a third chamber of the cluster tool; and
depositing a gate electrode layer on the annealed, treated metal-containing oxide layer in a fourth chamber of the cluster tool.

2. The method of claim 1, further comprising:
precleaning the substrate in a precleaning chamber of the cluster tool prior to depositing the metal-containing oxide layer.

3. The method of claim 1, further comprising:
exposing the metal-containing oxide layer to a post deposition anneal process in the cluster tool prior to performing the inert plasma process.

4. The method of claim 2, further comprising:
transferring the substrate within the cluster tool from a precleaning chamber through a load lock chamber to the first chamber.

5. The method of claim 2, wherein the step of precleaning the substrate further comprises:
removing an oxide layer from the substrate.

6. The method of claim 1, wherein the metal-containing oxide layer comprises at least one element selected from the group consisting of hafnium, tantalum, titanium, aluminum, zirconium, lanthanum and combinations thereof.

7. The method of claim 1, wherein the step of treating the metal-containing oxide layer with the inert plasma process further comprises
forming a plasma from an inert gas containing at least one of a nitrogen-containing gas, argon, helium or neon.

8. The method of claim 1, wherein the step of treating the metal-containing oxide layer with the inert plasma process further comprises:
treating the layer from about 30 seconds to about 5 minutes; and
applying from about 500 watts to about 3,000 watts of power to maintain a plasma in the second chamber.

9. The method of claim 1, wherein the step of annealing the metal-containing oxide layer further comprises:
maintaining the metal-containing oxide layer from about 600 to about 1,200 degrees Celsius for a duration of about 1 second to about 120 seconds.

10. The method of claim 9, wherein the step of annealing the metal-containing oxide layer further comprises:
flowing oxygen gas into the third chamber.

11. The method of claim 1, wherein the step of depositing the gate electrode layer further comprises:
depositing a polysilicon layer.

12. The method of claim 1, wherein the step of depositing the gate electrode layer further comprises:
depositing a metal-containing layer.

13. The method of claim 12, wherein the metal-containing layer is at least one of tantalum nitride, titanium nitride, tantalum silicon nitride, titanium silicon nitride, tantalum carbide, titanium aluminum nitride, ruthenium tantalum, molybdenum nitride or tungsten nitride.

14. The method of claim 12, wherein the step of depositing the metal-containing layer further comprises:
depositing a metal layer on the top of the metal-containing layer.

15. The method of claim 14, wherein the metal layer is at least one of titanium, tantalum, ruthenium or molybdenum.

16. The method of claim 12, wherein the step of depositing a metal-containing layer further comprises:
depositing a second metal-containing layer on the top of the first metal-containing layer.

17. The method of claim 16, wherein the second metal-containing layer is at least one of tantalum nitride, titanium nitride, tantalum silicon nitride, titanium silicon nitride, tantalum carbide, titanium aluminum nitride, ruthenium tantalum, molybdenum nitride or tungsten nitride.

18. The method of claim 12, wherein the step of depositing the metal-containing layer further comprises:
depositing a polysilicon layer on the metal-containing layer.

19. The method of claim 14, wherein the step of depositing the metal layer further comprises:
depositing a polysilicon layer on the top of the metal layer.

20. The method of claim 16, wherein the step of depositing a second metal-containing layer further comprises:
depositing a polysilicon layer on the top of the second metal-containing layer.

21. A method for forming dielectric materials on a substrate in a single cluster tool, comprising:
providing a cluster tool having a plurality of deposition chambers;
precleaning a substrate of the cluster tool;
depositing a metal-containing oxide layer on the substrate in a first chamber of the cluster tool;
treating the metal-containing oxide layer with an insert plasma process in a second chamber of the cluster tool;
annealing the treated metal-containing oxide layer in a third chamber of the cluster tool; and
depositing a gate electrode layer on the annealed treated metal-containing oxide layer in a fourth layer chamber of the cluster tool.

22. The method of claim 21, wherein the step of depositing the metal-containing oxide layer further comprises:
exposing the metal-containing oxide layer to a post deposition anneal process in the cluster tool prior to performing the inert plasma process.

23. A method for forming dielectric materials on a substrate in a single cluster tool, comprising:
providing a cluster tool having a plurality of deposition chambers;
precleaning a substrate in the cluster tool;
depositing a metal-containing oxide layer on the substrate in the cluster tool;
annealing the metal-containing oxide layer with a post deposition anneal process in the cluster tool;
treating the metal-containing oxide layer with an insert plasma process in the cluster tool;
annealing the treated metal-containing oxide layer in the cluster tool; and
depositing a gate electrode layer on the annealed, treated metal-containing oxide layer in the cluster tool.

24. The method of claim 23, further comprising:
performing the anneal process and the deposition of metal-containing oxide layer in a same process chamber.

25. The method of claim 23, further comprising:
performing the anneal process and the annealing of the treated metal-containing oxide layer in a same process chamber of the cluster tool.
